(19) United States
(12) Patent Application Publication
(10) Pub. No.: US 2024/0301752 A1
(43) Pub. Date: Sep. 12, 2024

(54) CONNECTING STRUCTURE OF HANDRAIL AND LADDER FRAME OF LAMBDOID FOLDABLE LADDER

(71) Applicant: New-Tec Integration (Xiamen) Co., Ltd., Xiamen City (CN)

(72) Inventor: Luhao LENG, Xiamen City (CN)

(21) Appl. No.: 18/369,748

(22) Filed: Sep. 18, 2023

(30) Foreign Application Priority Data
Mar. 6, 2023 (CN) 202320391611.8

(51) Int. Cl. E06C 7/18; E06C 1/20; E06C 7/08; E06C 7/14; E06C 7/50

(52) U.S. Cl. CPC E06C 7/182; E06C 1/20; E06C 7/08; E06C 7/14; E06C 7/50; E06C 1/387

(57) ABSTRACT

A connecting structure of a handrail and a ladder frame of a lambdoid foldable ladder is provided. A plastic fastening member is disposed on a front leg tube, and a top end of a rear leg tube is rotatably connected to the plastic fastening member, so as to enable the front leg tube and the rear leg tube to form a lambdoid rotatable structure. The vertical rod is parallel to the front leg tube and is configured to slide to pass through the plastic fastening member. The rear leg tube and the vertical rod are disposed on an outside of the front leg tube, and a connecting position of the rear leg tube and the plastic fastening member is located at a rear position of the outside of the front leg tube. The vertical rod is located at a front position of the outside of the front leg tube.

### RELATED APPLICATIONS

This application claims priority to Chinese patent application number 202320391611.8, filed on Mar. 6, 2023. Chinese patent application number 202320391611.8 is incorporated herein by reference.

### FIELD OF THE DISCLOSURE

The present disclosure relates to a mounting structure of a handrail of a ladder, and in particular to a connecting structure of a handrail and a ladder frame of a lambdoid foldable ladder.

### BACKGROUND OF THE DISCLOSURE

A ladder with a handrail disposed thereon can improve safety of use, so most of the ladders are disposed with a handrail. However, a structure of the handrail on different types of the ladders is different. In a first example, the handrail can be fixedly connected to a supporting leg of the ladder. In this example, a height of the handrail cannot be adjusted. The height of the handrail cannot be too high or it will cause a storage problem, and the handrail cannot be adjusted according to different heights of users to obtain a comfortable use state. In a second example, the handrail is slidingly connected to the supporting leg of the ladder, and the handrail can slide relative to the supporting leg, so that the user can adjust the height of the handrail to obtain a comfortable and safe use state. A slidable handrail disposed on the existing ladders is inserted into the supporting leg, which has a simple structure. However, a size of the supporting leg is relatively increased, and a thickness of the ladders also increases after being folded, which is inconvenient for storage.

### BRIEF SUMMARY OF THE DISCLOSURE

The present disclosure provides a connecting structure of a handrail and a ladder frame of a lambdoid foldable ladder to solve the deficiencies in the background, and the lambdoid foldable ladder is flatter and thinner when the lambdoid foldable ladder is in a folded state.

In order to solve the technical problem, a first technical solution of the present disclosure is as follows.

A connecting structure of a handrail and a ladder frame of a lambdoid foldable ladder is provided. The handrail comprises a vertical rod, and the ladder frame comprises a front leg tube, a rear leg tube, and a plastic fastening member. The plastic fastening member is disposed on a top end of the front leg tube, and a top end of the rear leg tube is rotatably connected to the plastic fastening member, so as to enable the front leg tube and the rear leg tube to form a lambdoid rotatable structure. The vertical rod is parallel to the front leg tube and is configured to slide to pass through the plastic fastening member, and the rear leg tube and the vertical rod are disposed on an outside of the front leg tube. A connecting position of the rear leg tube and the plastic fastening member is located at a rear position of the outside of the front leg tube, and the vertical rod is located at a front position of the outside of the front leg tube.

In a preferred embodiment, the plastic fastening member comprises an insert groove having a first bottom opening and corresponding to the front leg tube, and the plastic fastening member further comprises an arc-shaped mounting groove having a second bottom opening and corresponding to the rear leg tube.

In a preferred embodiment, a cross-section of the front leg tube is rectangular, a cross-section of the rear leg tube is a square, and a cross-section of the vertical rod is circular.

In a preferred embodiment, a diameter of the vertical rod is smaller than a width of the rear leg tube.

In a preferred embodiment, the ladder frame further comprises a sliding sleeve, and the sliding sleeve is slidably sleeved on the front leg tube. A bottom end of the vertical rod is connected to the sliding sleeve, and the vertical rod is configured to drive the sliding sleeve to slide on the front leg tube.

In a preferred embodiment, two of the vertical rods in a left side and a right side of the handrail are respectively connected to and matched with two of the ladder frames in a left side and a right side of lambdoid foldable ladder, and the handrail further comprises a supporting tray connected to top ends of the two of the vertical rods.

In a preferred embodiment, the sliding sleeve is disposed with a movable lid, and the movable lid is disposed with an inserting pin. The front leg tube comprises one or more positioning holes, and the inserting pin is configured to be driven by an elastic member to be inserted into the one or more positioning holes to enable the vertical rod to be locked.

In a preferred embodiment, the movable lid is U-shaped, and the sliding sleeve comprises a sliding groove corresponding to the movable lid. The inserting pin is connected to an inside of the movable lid, and the elastic member is tensioned or compressed between the sliding sleeve and the inserting pin. The movable lid is configured to be moved to an outside of the sliding sleeve to drive the inserting pin to move away from the sliding sleeve.

In a preferred embodiment, the front leg tube comprises a plurality of positioning holes at intervals along a length direction of the front leg tube.

In a preferred embodiment, a top of the supporting tray comprises an opening having a receiving cavity.

Compared with the existing techniques, the technical solution has the following advantages.

1. The vertical rod passes through the plastic fastening member to achieve a slidable structure, which is novel. The vertical rod of the handrail and the rear leg tube are located on the outside of the front leg tube, and the vertical rod of the handrail and the rear leg tube are located respectively on a front side and a rear side of the outside of the front leg tube. The front leg tube can be thinner, a folding process of the lambdoid foldable ladder will not be affected, and a total thickness of the lambdoid foldable ladder can be thinner.

2. The sliding sleeve is connected to the bottom end of the vertical rod and slides along the front leg tube, which can facilitate sliding of the handrail and better improve strength and stability of the handrail.

3. The supporting tray can not only place tools, but also play a supporting role, further improving the safety of use.

4. The movable lid can easily pull the inserting pin to release the vertical rod, so it is very convenient to unlock the handrail.

### BRIEF DESCRIPTION OF THE DRAWINGS

FIG. 1 illustrates a perspective view of a lambdoid foldable ladder.

FIG. 2 illustrates a front view of the lambdoid foldable ladder in a folded state in FIG. 1.

FIG. 3 illustrates a side view of the lambdoid foldable ladder in the folded state in FIG. 1.

FIG. 4 illustrates a cross-sectional view of the lambdoid foldable ladder along an A-A line in FIG. 2.

FIG. 5 illustrates a cross-sectional view of the lambdoid foldable ladder along a B-B line in FIG. 2.

FIG. 6 illustrates a perspective view of a sliding sleeve in a normal state.

FIG. 7 illustrates a perspective view of the sliding sleeve sliding outward.

### DETAILED DESCRIPTION OF THE EMBODIMENTS

The present disclosure will be further described below in combination with the accompanying drawings and embodiments.

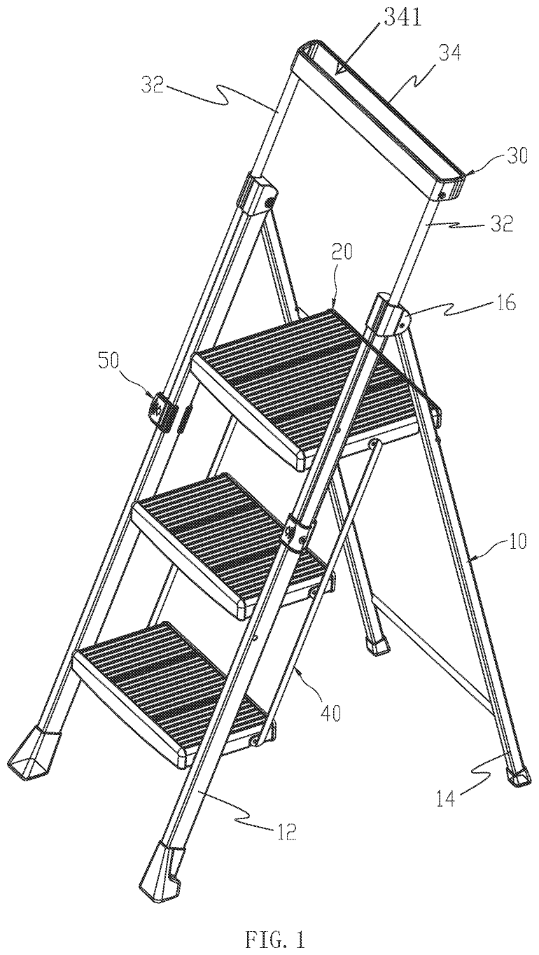

Referring to FIG. 1, a lambdoid foldable ladder is provided and comprises two ladder frames 10 symmetrically disposed in a left-and-right direction, a plurality of stepping platforms 20 connected to the two ladder frames 10, a handrail 30 connected to the two ladder frames 10, and two linkage rods 40 connected to two sides of the plurality of stepping platforms 20 and enabling the plurality of stepping platforms 20 to be operatively coupled to one another. The method of connecting the elements and a rotating principle of the two ladder frames 10, the plurality of stepping platforms 20, and the two linkage rods 40 can be referenced in the prior art, and a connecting structure of the handrail 30 and the two ladder frames 10 will be further described below.

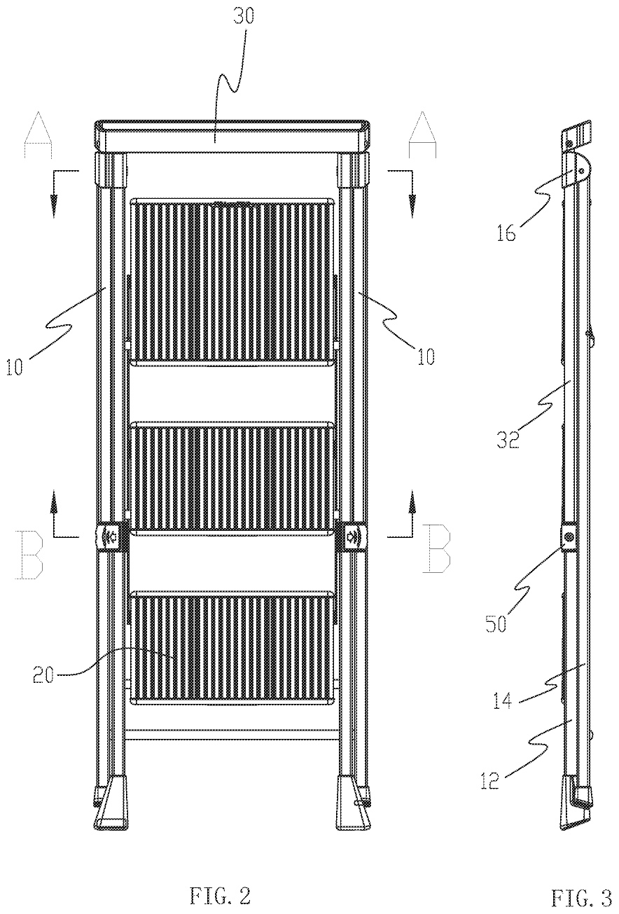

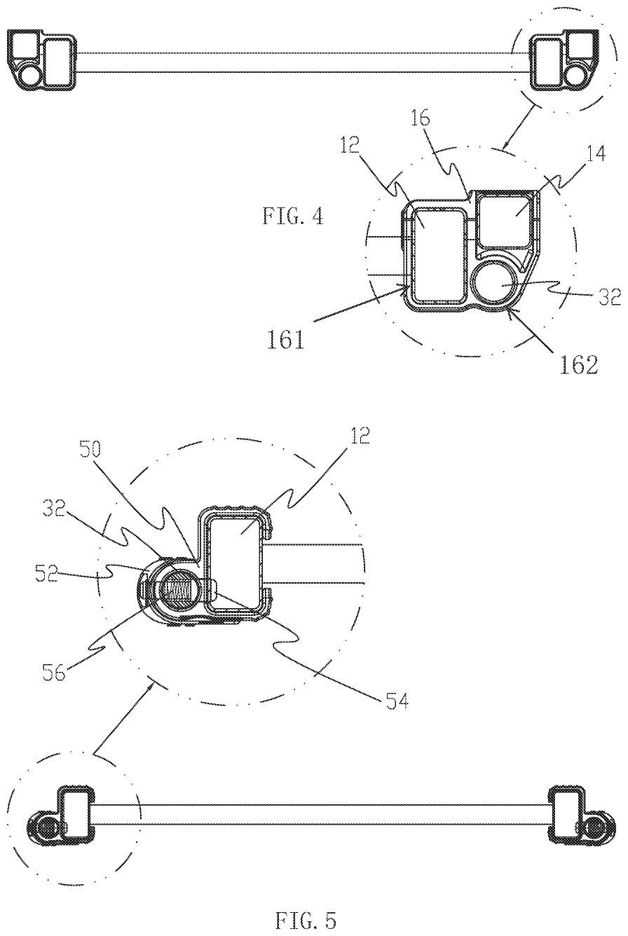

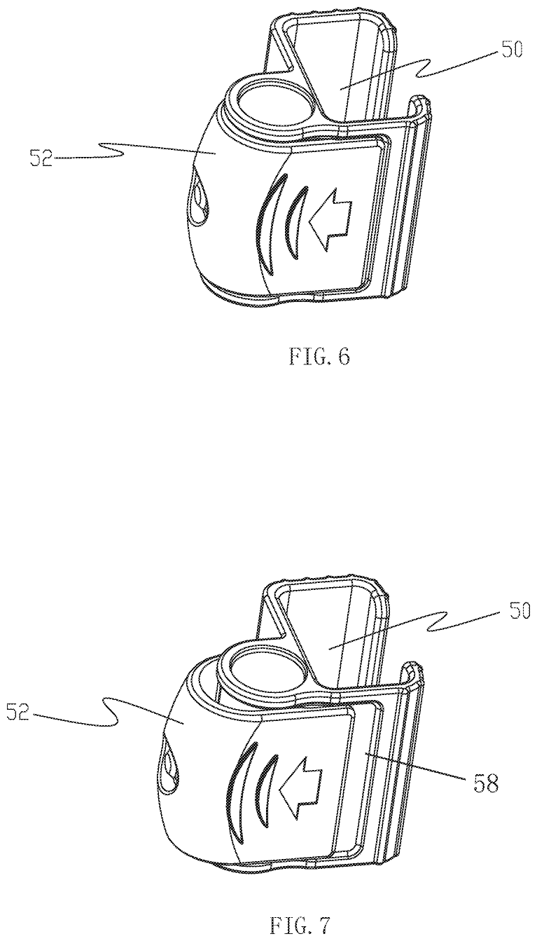

Referring to FIGS. 1-7, the handrail 30 comprises a vertical rod 32. Each of the two ladder frames 10 comprises a front leg tube 12, a rear leg tube 14, and a plastic fastening member 16. The plastic fastening member 16 is disposed on a top end of the front leg tube 12, and a top end of the rear leg tube 14 is rotatably connected to the plastic fastening member 16, so as to enable the front leg tube 12 and the rear leg tube 14 to form a lambdoid rotatable structure. The vertical rod 32 is parallel to the front leg tube 12 and is configured to slide to pass through the plastic fastening member 16, and the rear leg tube 14 and the vertical rod 32 are disposed on an outside of the front leg tube 12 (i.e., referring to FIG. 4, an outside of the lambdoid foldable ladder). Specifically, a connecting position of the rear leg tube 14 and the plastic fastening member 16 is located at a rear position of the outside of the front leg tube 12, and the vertical rod 32 is located at a front position of the outside of the front leg tube 12. The arrangement structure of the vertical rod 32, the front leg tube 12, the rear leg tube 14, and the plastic fastening member 16 enables the lambdoid foldable ladder to be flatter and thinner when the lambdoid foldable ladder is in a folded state and enables the front leg tube 12 and/or the rear leg tube 14 to be thinner.

Preferably, the plastic fastening member 16 comprises an insert groove having a first bottom opening 161 and corresponding to the front leg tube 12, and the plastic fastening member 16 further comprises an arc-shaped mounting groove having a second bottom opening 162 and corresponding to the rear leg tube 14, so that a top of the plastic fastening member 16 is more complete and smooth and the structure of the plastic fastening member 16 is more novel.

Preferably, a cross-section of the front leg tube 12 is rectangular, a cross-section of the rear leg tube 14 is a square, and a cross-section of the vertical rod 32 is circular. More preferably, a diameter of the vertical rod 32 is smaller than a width of the rear leg tube 14.

Preferably, each of the two ladder frames 10 further comprises a sliding sleeve 50, and the sliding sleeve 50 is slidably sleeved on the front leg tube 12. A bottom end of the vertical rod 32 is connected to the sliding sleeve 50, and the vertical rod 32 is configured to drive the sliding sleeve 50 to slide on the front leg tube 12.

It can be understand that the lambdoid foldable ladder comprises the two ladder frames 10 disposed symmetrically in the left-and-right direction. The handrail 30 comprises two of the vertical rods 32 disposed symmetrically in the left-and-right direction, and two of the vertical rods 32 in a left side and a right side of the handrail 30 are respectively connected to and matched with the two ladder frames 10 in a left side and a right side of lambdoid foldable ladder. The handrail 30 further comprises a supporting tray 34 connected to top ends of the two of the vertical rods 32.

Preferably, the sliding sleeve 50 is disposed with a movable lid 52, and the movable lid 52 is disposed with an inserting pin 54. The front leg tube 12 comprises one or more positioning holes, and the inserting pin 54 is configured to be driven by an elastic member 56 to be inserted into the one or more positioning holes to enable the vertical rod 32 to be locked.

Preferably, the movable lid 52 is U-shaped. The sliding sleeve 50 comprises a sliding groove 58 corresponding to the movable lid 52. The inserting pin 54 is connected to an inside of the movable lid 52, and the elastic member 56 is tensioned or compressed between the sliding sleeve 50 and the inserting pin 54. The movable lid 52 is configured to be moved to an outside of the sliding sleeve 50 to drive the inserting pin 54 to move away from the sliding sleeve 50.

In this embodiment, the front leg tube 12 comprises a plurality of positioning holes at intervals along a length direction thereof, so that the handrail 30 has more height adjusting gears, which makes the height of the handrail 30 flexible. In addition, a top of the supporting tray 34 comprises an opening having a receiving cavity 341 for more conveniently placing tools and parts.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A connecting structure of a handrail and a ladder frame of a lambdoid foldable ladder, wherein:
the handrail comprises a vertical rod,
the ladder frame comprises a front leg tube, a rear leg tube, and a plastic fastening member,
the plastic fastening member is disposed on a top end of the front leg tube, and a top end of the rear leg tube is rotatably connected to the plastic fastening member, so as to enable the front leg tube and the rear leg tube to form a lambdoid rotatable structure,
the vertical rod is parallel to the front leg tube and is configured to slide to pass through the plastic fastening member,
the rear leg tube and the vertical rod are disposed on an outside of the front leg tube,
a connecting position of the rear leg tube and the plastic fastening member is located at a rear position of the outside of the front leg tube, and
the vertical rod is located at a front position of the outside of the front leg tube.

2. The connecting structure of the handrail and the ladder frame of the lambdoid foldable ladder according to claim 1, wherein:
the plastic fastening member comprises an insert groove having a first bottom opening and corresponding to the front leg tube, and
the plastic fastening member further comprises an arc-shaped mounting groove having a second bottom opening and corresponding to the rear leg tube.

3. The connecting structure of the handrail and the ladder frame of the lambdoid foldable ladder according to claim 1, wherein:
a cross-section of the front leg tube is rectangular,
a cross-section of the rear leg tube is a square, and
a cross-section of the vertical rod is circular.

4. The connecting structure of the handrail and the ladder frame of the lambdoid foldable ladder according to claim 3, wherein:
a diameter of the vertical rod is smaller than a width of the rear leg tube.

5. The connecting structure of the handrail and the ladder frame of the lambdoid foldable ladder according to claim 1, wherein:
the ladder frame further comprises a sliding sleeve,
the sliding sleeve is slidably sleeved on the front leg tube,
a bottom end of the vertical rod is connected to the sliding sleeve, and
the vertical rod is configured to drive the sliding sleeve to slide on the front leg tube.

6. The connecting structure of the handrail and the ladder frame of the lambdoid foldable ladder according to claim 5, wherein:
two of the vertical rods in a left side and a right side of the handrail are respectively connected to and matched with two of the ladder frames in a left side and a right side of lambdoid foldable ladder,
the handrail further comprises a supporting tray connected to top ends of the two of the vertical rods.

7. The connecting structure of the handrail and the ladder frame of the lambdoid foldable ladder according to claim 5, wherein:
the sliding sleeve is disposed with a movable lid,
the movable lid is disposed with an inserting pin,
the front leg tube comprises one or more positioning holes, and
the inserting pin is configured to be driven by an elastic member to be inserted into the one or more positioning holes to enable the vertical rod to be locked.

8. The connecting structure of the handrail and the ladder frame of the lambdoid foldable ladder according to claim 7, wherein:
the movable lid is U-shaped,
the sliding sleeve comprises a sliding groove corresponding to the movable lid,
the inserting pin is connected to an inside of the movable lid,
the elastic member is tensioned or compressed between the sliding sleeve and the inserting pin, and
the movable lid is configured to be moved to an outside of the sliding sleeve to drive the inserting pin to move away from the sliding sleeve.

9. The connecting structure of the handrail and the ladder frame of the lambdoid foldable ladder according to claim 7, wherein:
the front leg tube comprises a plurality of positioning holes at intervals along a length direction of the front leg tube.

10. The connecting structure of the handrail and the ladder frame of the lambdoid foldable ladder according to claim 6, wherein:
a top of the supporting tray comprises an opening having a receiving cavity.

11. The connecting structure of the handrail and the ladder frame of the lambdoid foldable ladder according to claim 2, wherein:
a cross-section of the front leg tube is rectangular,
a cross-section of the rear leg tube is a square, and
a cross-section of the vertical rod is circular.

12. The connecting structure of the handrail and the ladder frame of the lambdoid foldable ladder according to claim 11, wherein:
a diameter of the vertical rod is smaller than a width of the rear leg tube.

13. The connecting structure of the handrail and the ladder frame of the lambdoid foldable ladder according to claim 6, wherein:
the sliding sleeve is disposed with a movable lid,
the movable lid is disposed with an inserting pin,
the front leg tube comprises one or more positioning holes, and
the inserting pin is configured to be driven by an elastic member to be inserted into the one or more positioning holes to enable the vertical rod to be locked.

14. The connecting structure of the handrail and the ladder frame of the lambdoid foldable ladder according to claim 13, wherein:
the movable lid is U-shaped,
the sliding sleeve comprises a sliding groove corresponding to the movable lid,
the inserting pin is connected to an inside of the movable lid,
the elastic member is tensioned or compressed between the sliding sleeve and the inserting pin, and
the movable lid is configured to be moved to an outside of the sliding sleeve to drive the inserting pin to move away from the sliding sleeve.

15. The connecting structure of the handrail and the ladder frame of the lambdoid foldable ladder according to claim 13, wherein:
the front leg tube comprises a plurality of positioning holes at intervals along a length direction of the front leg tube.
